(19) United States
(12) Patent Application Publication
(10) Pub. No.: US 2016/0033201 A1
(43) Pub. Date: Feb. 4, 2016

(54) METHOD FOR DRYING BULK MATERIAL

(71) Applicant: WITTMANN KUNSTSTOFFGERAETE GMBH, Wien (AT)

(72) Inventor: Erhard FUX, Wien (AT)

(73) Assignee: WITTMANN KUNSTSTOFFGERAETE GMBH, Wien (AT)

(21) Appl. No.: 14/776,885

(22) PCT Filed: Apr. 2, 2014
(86) PCT No.: PCT/AT2014/000068

§ 371 Date: Sep. 15, 2015

(30) Foreign Application Priority Data
Apr. 4, 2013 (AT) A 244/2013

(51) Int. Cl. F26B 21/08; F26B 21/04; F26B 3/06

(52) U.S. Cl. CPC F26B 21/083; F26B 3/06; F26B 21/04

(57) ABSTRACT

The invention relates to a method for drying bulk goods, in particular solids, such as granular materials, powders, grains, films, shreds, or the like, preferably plastic granular material, in a drying silo (7) by means of an air flow. The moistened returned air or the process air flow (10) that emerges from the drying silo (7) is dried in a drying cell containing a drying or adsorbent agent and returned in the form of a drying air flow (12) to the bulk goods again. The drying cell is preferably a wheel dryer (11) consisting of an air distribution cover and an air distribution floor having a rotatable drum arranged therebetween. The adsorbent agent is furthermore regenerated in the wheel dryer (11). The drum of the wheel dryer (11) is divided by the air distribution cover and the air distribution floor into two regions through which air is able to flow. One region (5) is used to regenerate the adsorbent agent and the other region (6) is used for drying or dehumidifying the process air flow (10). The region (6) for drying or dehumidifying the process air flow (10) adjoins the region (5) for regenerating the adsorbent agent, wherein the hot adsorbent agent is introduced uncooled into the region (6) for drying or dehumidifying the process air flow (10).

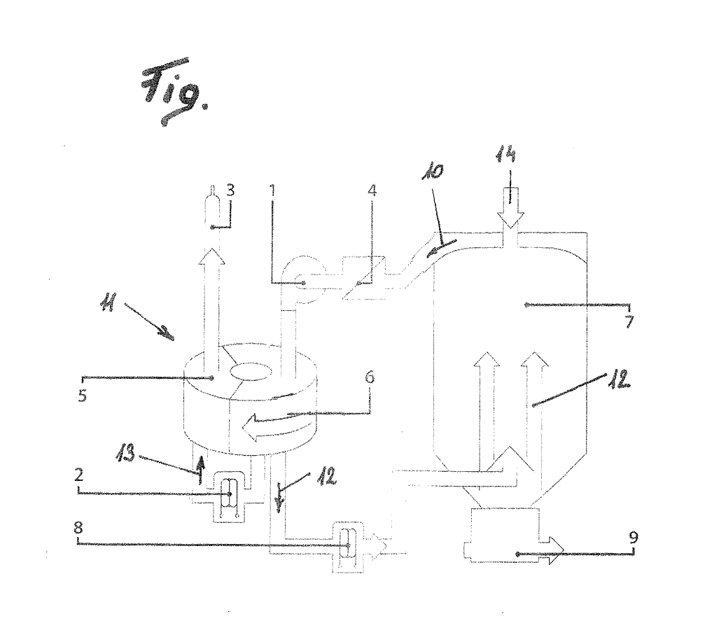

The invention relates to a method for drying bulk material, in particular solids, such as granulates, powder, grains, foils, chips, or the like, preferably plastic granulate, in a drying silo by means of an air flow, wherein the moistened returned air or the process air flow that emerges from the drying silo is dried in a drying cell containing a drying or adsorbent agent, said drying cell preferably being a wheel dryer consisting of an air distribution cover and an air distribution floor having a rotatable drum arranged therebetween, and returned in the form of a drying air flow to the bulk goods again and the adsorbent agent is furthermore regenerated in the wheel dryer.

Various methods and devices are known for drying the returned air that exits from the drying silo.

A method of the type cited above is known from AT 509 475 B1. In accordance with this known method, the adsorbent agent is regenerated and cooled in the wheel dryer. For this purpose, the rotatable drum of the wheel dryer is divided into at least three wheel segments, wherein the region of one wheel segment serves for drying or dehumidifying the process air flow, the region of the second wheel segment serves for heating or regenerating the adsorbent agent, and the region of the third wheel segment serves for cooling the adsorbent agent. The energy demand of this method is made up from the three parts of consumption during heating, cooling and the consumption for drying or dehumidifying.

DE 36 25 013 A1 shows another known method. In the course of said known method, the exhaust air exiting from the drying funnel is dried in a dryer containing an adsorbing agent and returned to the bulk goods as drying air. Furthermore, a method and a device for drying and heating air that serves for drying bulk goods is known from DE 197 57 537 A1. Said device essentially comprises at least one drying cartridge or drying cell, a downstream air heater, a downstream dry goods chamber or drying silo and a downstream cooling device.

Furthermore, a method for regenerating humidity-laden process air is known from DE 101 18 762 A1. Thereby, the atmospheric air is heated up and introduced to the drying cartridge for regeneration. The subsequent cooling of the drying cartridge is achieved by means of a partial stream of air diverted from the dried process air.

A method for drying humid air is known from EP 0 712 656 B1, and a method and a device for regenerating an adsorbent agent, containing in particular humidity, from EP 740 956 A2.

Moreover, a device with multiple chambers for selective adsorption of molecules is known from DE 2 025 205 A1.

A device of the type explained above is known from AT 505 391 B1. In accordance with said device, the exhaust air flow is introduced to a feeding channel that is provided in the wheel dryer and connected with the adsorbent, diverted in the wheel dryer, conducted through the adsorbent and subsequently diverted again as drying air flow and removed in a discharging channel against the direction of flow in the feeding channel, and introduced to the drying silo. One disadvantage of said wheel dryer is that high pressures are necessary due to the high flow resistances resulting from the diversions.

All the abovementioned methods and apparatuses primarily have the disadvantages that the devices require a very complex design and a high consumption of energy is given for said methods.

The aim of the invention is to create a method of the type mentioned above that on the one hand avoids the above disadvantages and on the other hand increases, globally seen, the economic efficiency, particularly in operation, both in the acquisition as well as during operation.

Said object is fulfilled by the invention.

The invention in accordance with the invention is characterized in that the drum of the wheel dryer is divided by the air distribution cover and the air distribution floor into two regions through which air is able to flow, wherein one region is used to regenerate the adsorbent agent and the other region is used for drying or dehumidifying the process air flow and that the region for drying or dehumidifying the process air flow adjoins the region for regenerating the adsorbent agent, wherein the hot adsorbent agent is introduced uncooled into the region for drying or dehumidifying the process air flow. With this method in accordance with the invention, it is for the first time possible to heavily reduce the energy consumption during operation in comparison with conventional methods.

Zeolite requires a temperature of more than 200 ° C. for regenerating, thus for dehumidifying and drying. The higher the temperature was, the better the efficiency would be. Depending on temperature, time and air flow, a specific cost of energy is therefore necessary for regenerating a certain amount of zeolite. As a result, the optimal energy consumption can be determined based on the degree of humidity of the zeolite. An energy supply in excess of the saturation range is useless. However, there are limits to the height of the temperature in view of the temperature resistance of the machinery parts and components involved in the process, such as seals, which is at approximately 280°.

As is generally known, the energy consumption for drying and dehumidifying the exhaust air airflow is determined very much by the heating output in the regenerating phase. The achievement of a constant dew point was in accordance with the methods of the state of the art as well as their philosophy. To achieve this dew point, a cooling phase was planned after the regenerating phase. In said cooling phase, the adsorbent agent was cooled to less than 80° C.

In accordance with the philosophy underlying this invention, namely to at least maintain the quality standard of the drying air in relation to existing systems, but increase the economic efficiency by energy efficiency, the cooling phase before the drying and dehumidifying of the adsorbent agent is waived deliberately. In accordance with the present invention, and this must be considered as the significant advantage, this energy consumption is saved by introducing the hot adsorbent agent uncooled into the region for drying or dehumidifying the process air flow. The energy-saving is approximately 15 to 25%.

As is generally known, devices with cartridges or with the wheel dryer are in use for drying and dehumidifying the returned air airflow. Particularly in tropical areas, the cartridge dryers are often unwanted. Thus, wheel dryers are used in these areas. Wheel dryers generally have the advantage that they operate independently. The present method in accordance with the invention is principally suitable for both uses.

In accordance with a very special feature of the invention, the regeneration air flow for regenerating the adsorbent agent is taken from the process air flow as partial air flow. As a result of this measure, the heating output is reduced due to the dry air. Possible moistening by outside air is avoided. However, the significant advantage must be seen in the fact that for this system no separate fan has to be provided for the regeneration air flow.

In accordance with another feature of the invention, the drying and dehumidifying for the process air flow and the regenerating of the adsorbent agent occur in parallel, in particular in a continuous manner during permanent operation. A distinction is made in the drying method between high and low water load. Based on this conclusion, the regenerating phase is carried out at a high water load during permanent operation pursuant to the present method in accordance with the invention.

In accordance with a very special further development of the invention, the regenerating of the adsorbent agent is carried out during operation at intervals, whereby the drum of the wheel dryer is stopped and advanced to a selectable region, preferably the region for regenerating, after the regenerating. As already mentioned, a distinction is made in the drying method between high and low water load. Based on this conclusion, the regenerating phase is carried out at a low water load during operation at intervals pursuant to the present method in accordance with the invention. This means that the heater for heating the adsorbent agent and, where applicable, the associated fan are switched off deliberately for a period of time. With this type of operation at intervals, the curve for the dew point deviates only insignificantly from the ideal curve, whereby however the deviation for the quality standard is unnoticeable.

In accordance with another embodiment of the invention, the heater for the regenerating, during operation at intervals, while the drum stands still, is switched off after the regeneration and the unheated partial flow of the process air flow flows through the region for regenerating. Advantageously, an optimal dew point for drying and dehumidifying is achieved this way.

In accordance with another special embodiment of the invention, the region for regenerating is defined smaller than the region for drying or dehumidifying the process air flow. This way, a continuous overall process is enabled in an advantageous way, whereby an optimal constant dew point is achieved throughout the operating time as a result of the smaller spatial unit for regenerating the adsorbent agent.

In accordance with a special embodiment of the invention, the region for drying or dehumidifying amounts to approximately 260 to 300 arc degrees and the region for heating or regenerating amounts to approximately 60 to 100 arc degrees. As has been shown in tests, an optimal dew point for drying and dehumidifying is achieved this way.

In accordance with a further development of the invention, multiple units, consisting of a region for regenerating and a region for drying and dehumidifying, are provided, by means of the airflow predefined by the air distribution cover or air distribution floor, on the rotatable drum of the wheel dryer. As a result, scaling of the method in accordance with the invention on a wheel dryer is enabled.

The invention will now be explained in more detail based on an embodiment which is illustrated in the drawing.

The figure shows a diagram of the method.

In accordance with the figure, the airflows for the method for drying bulk material, in particular solids, such as granulates, powder, grains, foils, chips, or the like, preferably plastic granulate, are shown schematically. The plastic granulate is dried in a drying silo 7 by means of a drying air flow 12. In order to dry the returned air or process air flow 10 that emerges from the drying silo 7 loaded with humidity in the region 6 of the drying or dehumidifying phase, the process air flow 10 is connected by means of a returned air filter 4 and a process fan 1 to the wheel dryer 11 that contains a drying or adsorbing agent. The process air flow 10 is dried in the wheel dryer 11. The process air flow 10 is reintroduced to the drying silo 7 via a heater 8 as drying air flow 12.

The drying silo 7 is filled, for example with plastic granulate, by means of a feeder 14. The dried plastic granulate is removed from the drying silo 7 for further processing by means of a suction box 9.

The wheel dryer 11 consists of an air distribution cover and an air distribution floor having a rotatable drum arranged therebetween.

The drum of the wheel dryer 11 is divided by the air distribution cover and the air distribution floor into two regions through which air is able to flow. One region 5 is used to regenerate the adsorbent agent and the other region 6 is used for drying or dehumidifying the process air flow 10. The region 6 for drying or dehumidifying the process air flow 10 adjoins the region 5 for regenerating the adsorbent agent, wherein the hot adsorbent agent is introduced uncooled into the region 6 for drying or dehumidifying the process air flow.

The adsorbent agent is regenerated in the wheel dryer 11 in the region 5, the regenerating phase. For regenerating the adsorbent agent, a regeneration air flow 13 is taken from the process air flow 10 as partial air flow. The regeneration air flow 13 is conducted via a regeneration heater 2, heated and then introduced to the wheel dryer 11. After flowing through the wheel dryer 11, the regeneration air flow 13 is discharged into the environment by means of an exhaust shaft 3. Advantageously, a separate fan therefore does not have to be provided for the system for the regeneration air flow 13.

The drying or dehumidifying phase 6 for the process air flow 10 is carried out in a continuous manner during permanent operation. Preferably, the regenerating of the adsorbent agent is also carried out in parallel to the drying or dehumidifying phase during permanent operation.

As mentioned already, zeolite requires a temperature of more than 200 ° C. for regenerating, thus for dehumidifying and drying. Depending on temperature, time and air flow, a specific cost of energy is therefore necessary for regenerating a certain amount of zeolite.

Furthermore, it is known that a temperature in the dimension of 80° C., for some granulate types even up to 180° C., is optimal for the region 6, the drying and dehumidifying of the process air flow 10.

In accordance with the known methods related to the state of the art, see for example AT 509 475 B1, the adsorbent agent that exits the region 5 for regenerating is cooled in a separate region of the wheel dryer 11 with a cost of energy. In accordance with the philosophy underlying this invention, namely to at least maintain the quality standard of the drying air in relation to existing systems, but increase the economic efficiency, this cooling phase is waived deliberately. The energy that is quasi surplus in the adsorbent agent due to the regeneration is used as stored energy in the drying and dehumidifying phase.

By waiving the cooling phase, an energy-saving of approximately 15 to 25% of the total energy consumption results during operation of the system.

It is known that the optimal energy consumption can therefore be determined based on the degree of humidity of the zeolite. Thus, an energy supply in excess of the saturation range does not result in any significantly better degree of efficiency and is a waste of energy. As is furthermore generally known, the energy consumption of the drying process in the drying or dehumidifying phase is determined very much by the heating output in the regenerating phase.

In order to continue to pursue the philosophy underlying the invention now, namely to at least maintain the quality standard of the drying air in relation to existing systems, but increase the economic efficiency, a distinction is deliberately made in the drying method between high and low water load. Based on this conclusion, the regenerating phase is carried out at a low water load during operation at intervals pursuant to the present method in accordance with the invention. This means that the regeneration heater 2 for heating the adsorbent agent is switched off for a period of time. The unheated partial flow of the process air flow 10 is able to flow through the region 5 for regenerating. With this type of operation at intervals, the curve for the dew point deviates only insignificantly from the ideal curve, whereby however the deviation for the quality standard is unnoticeable.

By a deliberate design, namely that the region 5 for regenerating is defined smaller than the region 6 for drying or dehumidifying the process air flow 10, further optimization of the overall process can be achieved. Preferably, the region 6 for drying or dehumidifying amounts to approximately 260 to 300 arc degrees and the region 5 for heating amounts to approximately 60 to 100 arc degrees.

For scaling of the method on the wheel dryer 11, it is possible, by means of the airflow predefined by the air distribution cover or air distribution floor, to provide multiple units, consisting of a region 5 for regenerating and region 6 for drying and dehumidifying, on the rotatable drum of the wheel dryer 11.

1. Method for drying bulk material, in particular solids, such as granulates, powder, grains, foils, chips, or the like, preferably plastic granulate, in a drying silo (7) by means of an air flow, wherein the moistened returned air or the process air flow (10) that emerges from the drying silo (7) is dried in a drying cell containing a drying or adsorbent agent, said drying cell preferably being a wheel dryer (11) consisting of an air distribution cover and an air distribution floor having a rotatable drum arranged therebetween, and returned in the form of a drying air flow (12) to the bulk goods again and the adsorbent agent is furthermore regenerated in the wheel dryer (11), characterized in that the drum of the wheel dryer (11) is divided by the air distribution cover and the air distribution floor into just two regions through which air is able to flow, wherein one region (5) is used to regenerate the adsorbent agent and the other region (6) is used for drying or dehumidifying the process air flow (10) and that the region (6) for drying or dehumidifying the process air flow (10) directly adjoins the region (5) for regenerating the adsorbent agent, wherein the hot adsorbent agent is introduced uncooled into the region (6) for drying or dehumidifying the process air flow (10).

2. Method in accordance with claim 1, characterized in that the regeneration air flow (13) for regenerating the adsorbent agent is taken from the process air flow (10) as partial air flow.

3. Method in accordance with claim 1, characterized in that the drying and dehumidifying for the process air flow (10) and the regenerating of the adsorbent agent occur in parallel, in particular in a continuous manner during permanent operation.

4. Method in accordance with claim 1, characterized in that the regenerating of the adsorbent agent is carried out during operation at intervals, whereby the drum of the wheel dryer (11) is stopped and advanced to a selectable region, preferably the region for regenerating, after the regenerating.

5. Method in accordance with claim 4, characterized in that, during operation at intervals, while the drum stands still, the heater (2) for the regenerating is switched off after the regeneration and the unheated partial flow of the process air flow (10) flows through the region for regenerating.

6. Method in accordance with claim 1, characterized in that the region (5) for regenerating is defined smaller than the region (6) for drying or dehumidifying the process air flow (10).

7. Method in accordance with claim 1, characterized in that the region (6) for drying or dehumidifying amounts to approximately 260 to 300 arc degrees and the region (5) for heating amounts to approximately 60 to 100 arc degrees.

8. Method in accordance with claim 1, characterized in that, by means of the airflow predefined by the air distribution cover or air distribution floor, multiple units, consisting of a region (5) for regenerating and a region (6) for drying and dehumidifying, are provided on the rotatable drum of the wheel dryer (11).
